(19) United States
(12) Patent Application Publication
(10) Pub. No.: US 2026/0001648 A1
(43) Pub. Date: Jan. 1, 2026

(54) Five-Constant Air-Conditioning System of Aircraft Cabin

(71) Applicant: CHANGZHOU UNIVERSITY, Changzhou (CN)

(72) Inventor: Mingxin LIU, Changzhou (CN)

(21) Appl. No.: 19/247,409

(22) Filed: Jun. 24, 2025

(30) Foreign Application Priority Data
Jun. 28, 2024 (CN) 202410862924.6

(51) Int. Cl. B64D 13/06; B64D 13/08

(52) U.S. Cl. CPC B64D 13/06; B64D 13/08; B64D 2013/0681

(57) ABSTRACT

Disclosed is a five-constant air-conditioning system of an aircraft cabin. The system includes an airframe and an internal cabin, where the airframe includes an air inlet and an air outlet provided on a surface and a fresh air assembly arranged between the airframe and the cabin; and the cabin includes an air supply outlet and an air exhaust outlet provided on an inner wall. According to the present disclosure, a temperature in the cabin is preliminarily regulated through a temperature regulating chamber by using air brought by the fresh air assembly, and the temperature is continuously regulated and controlled through a cold and hot medium pipeline assembly such that a constant temperature can be achieved. Constant humidity and constant quietness can be achieved through the fresh air assembly. Constant purification can be achieved through an air filter. Constant oxygen can be achieved through an oxygen increasing component.

### CROSS-REFERENCE TO RELATED APPLICATIONS

The present application claims priority to Chinese Patent Application No. 202410862924. 6, filed on Jun. 28, 2024, the entire disclosure of which is incorporated herein by reference.

### TECHNICAL FIELD

The present disclosure relates to the technical field of aircraft air conditioning, and particularly relates to a five-constant air-conditioning system of an aircraft cabin.

### BACKGROUND

Nowadays, a growing number of people travel by air with economic growth. Aircrafts are mainly used for long-distance flights. Since an environment in an aircraft cabin is closed, it is exceedingly significant to ensure comfort and health in the environment in the aircraft cabin. At present, a large volume of air including return air and fresh air is supplied to the aircraft cabin. Passengers are likely to have feelings of blowing. Moreover, air distribution in the cabin is closely linked to dispersion of various pollutants in the cabin. Thus, comfort and health risks of passengers and a crew are increased because of an unreasonable air conditioning design. Currently, a hybrid ventilation system is commonly used in a passenger aircraft cabin.

Existing research shows that through such a ventilation method, the passengers are likely to have the feelings of blowing due to large airflow at tops of heads, and feel uncomfortable after long-time blowing. No enough fresh air can be obtained in a breathing area. Pollutants produced by human bodies cannot be discharged in time, and are prone to spread to the entire cabin. Accordingly, comfort and health requirements of the passengers in the cabin cannot be satisfied.

An existing air-conditioning system of an aircraft delivers air having a proper temperature into a cabin by mixing fresh air and return air. Thus, a comfortable internal environment can be maintained for the passengers and the crew in the cabin. However, through such a system, the feelings of blowing of the passengers and a dispersion range of the pollutants are increased due to a large volume of air, and comfort and health of the passengers and the crew are affected by extremely low humidity in the cabin. In order to resolve the above problems, the present disclosure provides s a five-constant air-conditioning system of an aircraft cabin. An objective of the system is to achieve five-constant control of an internal environment of an aircraft cabin, that is, constant temperature control, constant humidity control, constant oxygen control, constant quietness control, and constant purification control.

### SUMMARY

Since the above air-conditioning system has a large number of problems affecting comfort of a passenger, the present disclosure is provided.

Thus, an objective of the present disclosure is to provide a five-constant air-conditioning system of an aircraft cabin.

In order to resolve the above technical problems, the present disclosure provides a technical solution as follows: The system includes:
an airframe and the cabin arranged in the airframe.

The airframe includes an air inlet provided on a surface of the airframe, an air outlet provided on the surface of the airframe, and a fresh air assembly arranged between the airframe and the cabin.

A one-way air valve is arranged at the air outlet.

The cabin includes an air supply outlet provided on an inner wall of the cabin, an air exhaust outlet provided on the inner wall of the cabin, and a cold and hot medium pipeline assembly fixedly connected to one end of the cabin.

In a preferred solution of the five-constant air-conditioning system of an aircraft cabin in the present disclosure, the fresh air assembly includes an air intake pipeline fixedly connected to one end of the air inlet, a temperature regulating chamber arranged at one end of the air intake pipeline, an air mixing chamber arranged on one side of the temperature regulating chamber, and a gas transmission pipeline arranged on one side of the air mixing chamber.

In a preferred solution of the five-constant air-conditioning system of an aircraft cabin in the present disclosure, an air sensor is arranged in the air intake pipeline. An air regulating valve is arranged behind the air sensor. An air filter is further mounted in the air intake pipeline.

The air regulating valve is fixedly mounted in the air intake pipeline.

In a preferred solution of the five-constant air-conditioning system of an aircraft cabin in the present disclosure, an air conditioner and a fan which is arranged at a top of the temperature regulating chamber are arranged in the temperature regulating chamber.

In a preferred solution of the five-constant air-conditioning system of an aircraft cabin in the present disclosure, a plurality of slide wheels fixedly mounted, a wire configured to link the slide wheels, a valve fixedly connected to one end of the wire, an air volume pusher slidably connected in the gas transmission pipeline, a limiting ring arranged at a bottom of the air volume pusher, and an oxygen increasing component mounted in the gas transmission pipeline are arranged in the gas transmission pipeline.

The valve is movably connected to the air intake pipeline.

In a preferred solution of the five-constant air-conditioning system of an aircraft cabin in the present disclosure, one end of the wire is fixedly connected to the air volume pusher, and the other end of the wire is fixedly connected to the valve.

In a preferred solution of the five-constant air-conditioning system of an aircraft cabin in the present disclosure, an air volume regulating assembly is mounted on a surface of the air supply outlet. The air volume regulating assembly includes a base snap-fitted on the air supply outlet, fixed fan blades fixedly connected to the base, rotary fan blades movably connected to sides of the fixed fan blades, and regulating bosses fixedly mounted on surfaces of the rotary fan blades.

In a preferred solution of the five-constant air-conditioning system of an aircraft cabin in the present disclosure, the air supply outlet and another same air supply outlet are symmetrically provided on the cabin, and the air exhaust outlet and another same air exhaust outlet are symmetrically provided on the cabin. In the cabin, n (n is an even number greater than 1) groups are provided according to a number of seats and an actual requirement.

In a preferred solution of the five-constant air-conditioning system of an aircraft cabin in the present disclosure, the cold and hot medium pipeline assembly includes a cold and hot medium supply pipeline fixedly connected to one end of the temperature regulating chamber, and a cold and hot medium circulation pipeline arranged at one end of the temperature regulating chamber.

In a preferred solution of the five-constant air-conditioning system of an aircraft cabin in the present disclosure, the cold and hot medium pipeline assembly is S-shaped and mounted on the inner wall of the cabin.

The present disclosure has beneficial effects as follows: A temperature in the cabin is preliminarily regulated and controlled through a temperature regulating chamber by using air brought by the fresh air assembly, and then the temperature in the cabin is continuously regulated and controlled through a cold and hot medium pipeline assembly such that a constant temperature effect can be achieved. A constant humidity effect and a constant quietness effect can be achieved through the fresh air assembly. A constant purification effect can be achieved through an air filter. Moreover, a constant oxygen effect can be achieved through an oxygen increasing component. Thus, comfort of a passenger can be improved.

### BRIEF DESCRIPTION OF DRAWINGS

In order to describe the technical solutions in the examples of the present disclosure more clearly, the accompanying drawings required to be used in the descriptions of the examples will be briefly introduced below. Apparently, the accompanying drawings in the following descriptions show merely some examples of the present disclosure. A person of ordinary skill in the art can further derive other accompanying drawings according to these accompanying drawings without making creative efforts. In the accompanying drawings,

FIG. 1 is a schematic diagram of a five-constant air-conditioning system of an aircraft cabin according to the present disclosure.

FIG. 2 is an internal distribution diagram of a five-constant air-conditioning system of an aircraft cabin according to the present disclosure.

FIG. 3 is a comparison diagram of opening a valve by using slide wheels of a five-constant air-conditioning system of an aircraft cabin according to the present disclosure.

FIG. 4 is a schematic diagram of opening an air volume regulating assembly according to the present disclosure.

FIG. 5 is a diagram of a shape of a cold and hot medium pipeline assembly according to the present disclosure.

### DETAILED DESCRIPTION OF THE EMBODIMENTS

In order to make the above objective, features and advantages of the present disclosure more apparent and understandable, particular embodiments of the present disclosure will be described in detail below in combination with the accompanying drawings.

Many particular details are set forth in the following descriptions to facilitate full understanding of the present disclosure, but the present disclosure can alternatively be implemented in other methods different from those described herein. Similar derivatives can be made by a person skilled in the art without departing from the connotation of the present disclosure. Thus, the present disclosure is not limited by the particular examples disclosed below.

Then, “an example” or “example” referred to herein means a particular feature, structure, or characteristic that can be included in at least one implementation of the present disclosure. The expresses “in an example” appearing in different portions of the description do not all refer to the same example, and are not denote separate or alternative examples mutually exclusive of other examples.

Further, the present disclosure will be described in detail in combination with schematic diagrams. When the examples of the present disclosure are described in detail, for convenience of explanation, sectional views denoting device structures will not be enlarged to normal scale. Moreover, the schematic diagrams are exemplary only, and should not limit the scope of protection of the present disclosure herein. In addition, three-dimensional spatial sizes of a length, a width, and a depth should be included during actual production.

### Example 1

With reference to FIG. 1, a first example of the present disclosure is shown. A five-constant air-conditioning system of an aircraft cabin is provided. The device includes an airframe 100 and a cabin 200 arranged in the airframe 100.

The airframe 100 includes an air inlet 101 provided on a surface of the airframe 100, an air outlet 102 provided on the surface of the airframe 100, and a fresh air assembly 103 arranged between the airframe 100 and the cabin 200.

A one-way air valve 102a is arranged at the air outlet 102.

The cabin 200 includes an air supply outlet 201 provided on an inner wall of the cabin 200, an air exhaust outlet 202 provided on the inner wall of the cabin 200, and a cold and hot medium pipeline assembly 203 fixedly connected to one end of the cabin 200.

Specifically, the fresh air assembly 103 includes an air intake pipeline 103a fixedly connected to one end of the air inlet 101, a temperature regulating chamber 103b arranged at one end of the air intake pipeline 103a, an air mixing chamber 103c arranged on one side of the temperature regulating chamber 103b, and a gas transmission pipeline 103d arranged on one side of the air mixing chamber 103c.

Further, an air sensor 103a-1 is arranged in the air intake pipeline 103a. An air regulating valve 103a-2 is arranged behind the air sensor 103a-1. An air filter 103a-3 is further mounted in the air intake pipeline 103a.

The air regulating valve 103a-2 is fixedly mounted in the air intake pipeline 103a.

More preferably, an air conditioner 103b-1 and a fan 103b-2 which is arranged at a top of the temperature regulating chamber 103b are arranged in the temperature regulating chamber 103b.

Furthermore, an air volume regulating assembly 201a is mounted on a surface of the air supply outlet 201. The air volume regulating assembly 201a includes a base 201a-1 snap-fitted on the air supply outlet 201, fixed fan blades 201a-2 fixedly connected to the base 201a-1, rotary fan blades 201a-3 movably connected to sides of the fixed fan blades 201a-2, and regulating bosses 201a-4 fixedly mounted on surfaces of the rotary fan blades 201a-3.

It should be noted that the air supply outlet 201 and another same air supply outlet are symmetrically provided on the cabin 200, and the air exhaust outlet 202 and another same air exhaust outlet are symmetrically provided on the cabin. In the cabin 200, n (n is an even number greater than 1) groups are provided according to a number of seats and an actual requirement.

During use, air enters the air intake pipeline 103a from an exterior of the airframe 100 through the air inlet 101, and the air passing through the air intake pipeline 103a passes through a sensor 103a-1. At this time, the sensor 103a-1 regulates the air regulating valve 103a-2 to control an air intake volume. When the air subsequently passes through the air filter 103a-3, impurities in the air are filtered out, and air is purified and dehumidified. Thus, a constant purification effect and a constant humidity effect are achieved. At this time, the air enters the temperature regulating chamber 103b, and is heated or cooled under the action of the air conditioner 103b-1. The air in the temperature regulating chamber 103b is delivered to the air mixing chamber 103c by the fans 103b-2, delivered to the gas transmission pipeline 103d, and discharged into the cabin 200 through the air supply outlet 201. The air volume regulating assembly 201a rotates the regulating bosses 201a-4 to move the rotary fan blades 201a-3 according to a personal requirement of a passenger such that an air speed can be freely controlled. Thus, a constant quietness effect is achieved. When more air exists in the cabin 200, the air can be discharged to an exterior of the cabin 200 through the air exhaust outlet 202. At this time, polluted air can be discharged together. Then, the polluted air is discharged to the exterior of the airframe 100 through the one-way air valve 102a.

To sum up, a constant purification effect and a constant humidity effect are achieved by arranging the fresh air assembly 103. An air output volume is regulated by adjusting the air volume regulating assembly 201a, such that the constant quietness effect is achieved. The passenger can choose, by himself/herself, whether to experience a feeling of blowing.

### Example 2

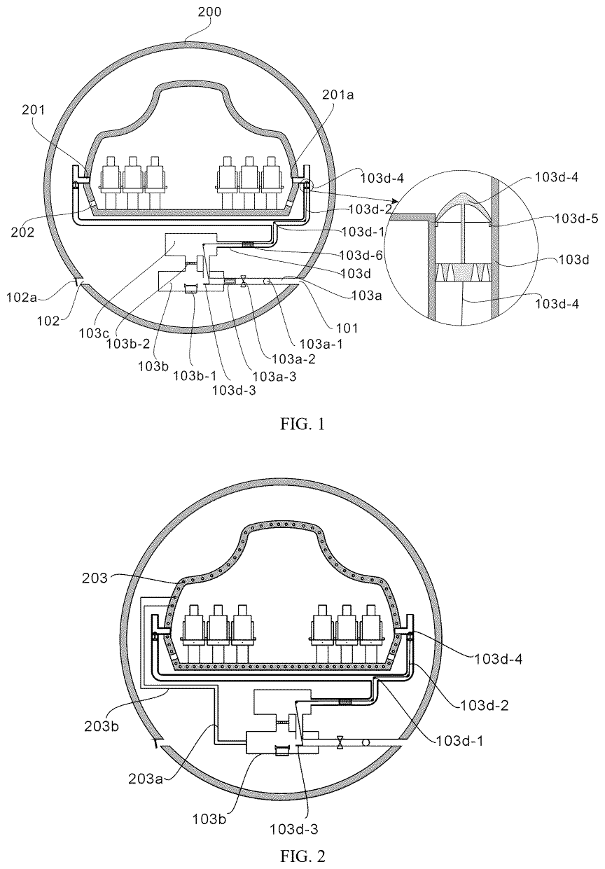

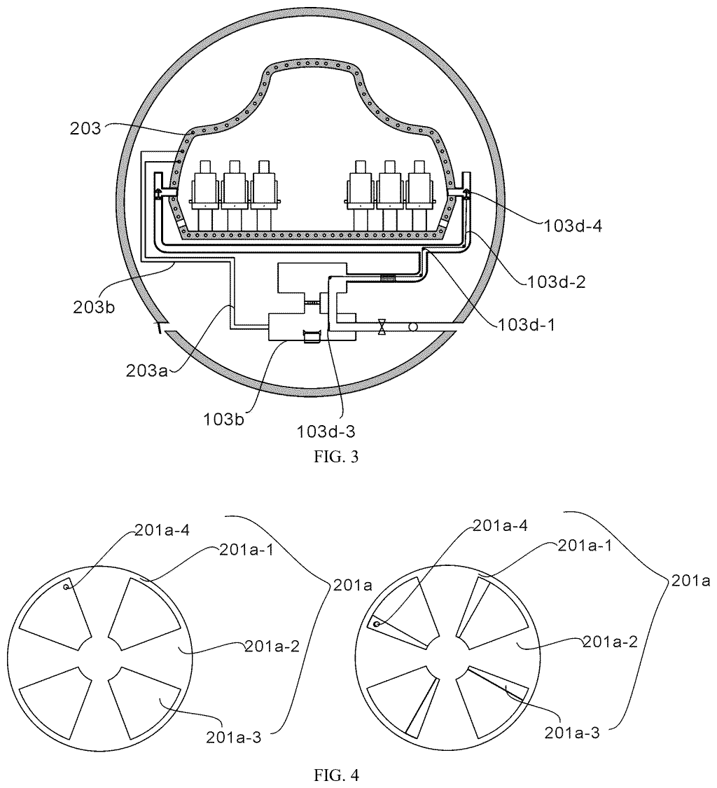

With reference to FIG. 1 to FIG. 3, a second example of the present disclosure is provided. Differing from the previous example, the example provides a ratchet short-circuit switch 203b.

Specifically, a plurality of slide wheels 103d-1 fixedly mounted, a wire 103d-2 configured to link the slide wheels 103d-1, a valve 103d-3 fixedly connected to one end of the wire 103d-2, an air volume pusher 103d-4 slidably connected in the gas transmission pipeline 103d, a limiting ring 103d-5 arranged at a bottom of the air volume pusher 103d-4, and an oxygen increasing component 103d-6 mounted in the gas transmission pipeline 103d are arranged in the gas transmission pipeline 103d.

The valve 103d-3 is movably connected to the air intake pipeline 103a.

Further, one end of the wire 103d-2 is fixedly connected to the air volume pusher 103d-4, and the other end of the wire is fixedly connected to the valve 103d-3.

When an aircraft runs a period of time, a oxygen content in the aircraft becomes low. At this time, an oxygen content in the gas transmission pipeline 103d can be increased by starting the oxygen increasing component 103d-6. Thus, comfort of a passenger can be improved. Then, the air volume pusher 103d-4 ascends by controlling an air intake volume and an air output volume of the air regulating valve 103a-2. A plurality of slide wheels 103d-1 are driven to rotate through the wire 103d-2 connected to the air volume pusher, such that the valve 103d-3 is closed. Thus, the air does not pass through the temperature regulating chamber 103b. At this time, the gas transmission pipeline 103d provides only oxygen gas, and air having a normal temperature such that discomfort of a passenger caused by long-time blowing at a low temperature produced by an air conditioner or a high temperature produced by a heater cannot occur.

To sum up, a constant oxygen effect is achieved in the cabin 200 by the oxygen increasing component 103d-6. Then, the valve 103d-3 is controlled to be opened by the air volume pusher 103d-4, such that the air supply outlet 201 does not spray air having a varying temperature any more. Thus, comfort of a passenger can be improved.

### Example 3

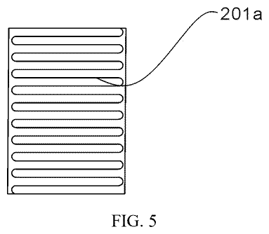

With reference to FIG. 1 to FIG. 5, a third example of the present disclosure is provided. Differing from the previous example, the example provide a differential gear set 203c including a first differential gear 203c-1 movably connected in a housing 203a and a second differential gear 203c-2 movably connected in the housing 203a and meshing with the first differential gear 203c-1.

Specifically, the cold and hot medium pipeline assembly 203 includes a cold and hot medium supply pipeline 203a fixedly connected to one end of the temperature regulating chamber 103b, and a cold and hot medium circulation pipeline 203b arranged at one end of the temperature regulating chamber 103b.

The cold and hot medium circulation pipeline 203b is filled with cold and hot media.

Further, the cold and hot medium pipeline assembly 203 is S-shaped and mounted on the inner wall of the cabin 200.

When the aircraft runs a period of time, the air conditioner 103b-1 heats or cools the cold and hot media in the cold and hot medium circulation pipeline 203b to a temperature. At this time, only oxygen gas, and air having a normal temperature are provided in the gas transmission pipeline 103d. A temperature in the cabin 200 radiates on the inner wall of the cabin 200 through the cold and hot medium circulation pipeline 203b such that a passenger can feel a uniform and comfortable temperature. Comfort of the passenger cannot be affected by cold and hot air blown out from the air supply outlet 201. A constant temperature effect is achieved.

To sum up, a temperature is transmitted to an interior of the cabin 200 through heat radiation by using the cold and hot media of the cold and hot medium pipeline assembly 203. Thus, comfort of a passenger is apparently improved.

It is important to note that constructions and arrangements of the present disclosure shown in a plurality of different exemplary implementation solutions are exemplary only. Although only a few implementation solutions are described in detail in the disclosure, a person making reference to the disclosure should readily appreciate that plenty of variations (such as changes in sizes, dimensions, structures, shapes, and scales of various elements, parameter values (such as temperatures and pressures), mounting and arrangements, usage of materials, colors, and orientations) are possible without substantially departing from the novel teachings and advantages of the subject matter described in the present disclosure. For example, an element shown as integrally formed may be constructed of a plurality of portions or elements. A position of the element may be inverted or otherwise changed. Moreover, a nature, number, or position of a discrete element may be altered or changed. Thus, all such variations are intended to fall within the scope of the present disclosure. An order or a sequence of any process or method steps can be changed or reordered according to alternative implementation solutions. In claims, any “device plus function” clause is intended to cover a structure described herein and performing the function, not only structural equivalents but also equivalent structures. Other substitutions, variations, changes, and omissions can be made in designs, operations, and arrangements of the exemplary implementation solutions without departing from the scope of the present disclosure. Thus, the present disclosure is not limited to particular implementation solutions, but extends to a variety of variations still falling within the scope of the appended claims.

In addition, in order to provide concise descriptions of exemplary implementation solutions, not all features of an actual implementation solution are described (that is, those features that are not related to the best mode currently considered and performing the present disclosure, or those features that are not related to implementation of the present disclosure).

It should be noted that the above examples are merely used for describing the technical solutions of the present disclosure rather than limiting the technical solutions of the present disclosure. Although the present disclosure is described in detail with reference to the preferred examples, a person of ordinary skill in the art should understand that amendments or equivalent substitutions can be made to the technical solutions of the present disclosure without departing from the spirit and scope of the technical solutions of the present disclosure. All the amendments or equivalent substitutions should all fall within the scope of the claims of the present disclosure.

What is claimed is:

1. A five-constant air-conditioning system of an aircraft cabin, comprising:
an airframe and the cabin arranged in the airframe, wherein
the airframe comprises an air inlet provided on a surface of the airframe, an air outlet provided on the surface of the airframe, and a fresh air assembly arranged between the airframe and the cabin;
a one-way air valve is arranged at the air outlet; and
the cabin comprises an air supply outlet provided on an inner wall of the cabin, an air exhaust outlet provided on the inner wall of the cabin, and a cold and hot medium pipeline assembly fixedly connected to one end of the cabin.

2. The five-constant air-conditioning system of an aircraft cabin according to claim 1, wherein the fresh air assembly comprises an air intake pipeline fixedly connected to one end of the air inlet, a temperature regulating chamber arranged at one end of the air intake pipeline, an air mixing chamber arranged on one side of the temperature regulating chamber, and a gas transmission pipeline arranged on one side of the air mixing chamber.

3. The five-constant air-conditioning system of an aircraft cabin according to claim 2, wherein an air sensor is arranged in the air intake pipeline, an air regulating valve is arranged behind the air sensor, and an air filter is further mounted in the air intake pipeline; and
the air regulating valve is fixedly mounted in the air intake pipeline.

4. The five-constant air-conditioning system of an aircraft cabin according to claim 3, wherein an air conditioner and a fan which is arranged at a top of the temperature regulating chamber are arranged in the temperature regulating chamber.

5. The five-constant air-conditioning system of an aircraft cabin according to claim 4, wherein a plurality of slide wheels fixedly mounted, a wire configured to link the slide wheels, a valve fixedly connected to one end of the wire, an air volume pusher slidably connected in the gas transmission pipeline, a limiting ring arranged at a bottom of the air volume pusher, and an oxygen increasing component mounted in the gas transmission pipeline are arranged in the gas transmission pipeline; and
the valve is movably connected to the air intake pipeline.

6. The five-constant air-conditioning system of an aircraft cabin according to claim 5, wherein one end of the wire is fixedly connected to the air volume pusher, and the other end of the wire is fixedly connected to the valve.

7. The five-constant air-conditioning system of an aircraft cabin according to claim 6, wherein an air volume regulating assembly is mounted on a surface of the air supply outlet, and the air volume regulating assembly comprises a base snap-fitted on the air supply outlet, fixed fan blades fixedly connected to the base, rotary fan blades movably connected to sides of the fixed fan blades, and regulating bosses fixedly mounted on surfaces of the rotary fan blades.

8. The five-constant air-conditioning system of an aircraft cabin according to claim 7, wherein the air supply outlet and another same air supply outlet are symmetrically provided on the cabin, the air exhaust outlet and another same air exhaust outlet are symmetrically provided on the cabin, and in the cabin, n (n is an even number greater than 1) groups are provided according to a number of seats and an actual requirement.

9. The five-constant air-conditioning system of an aircraft cabin according to claim 7, wherein the cold and hot medium pipeline assembly comprises a cold and hot medium supply pipeline fixedly connected to one end of the temperature regulating chamber, and a cold and hot medium circulation pipeline arranged at one end of the temperature regulating chamber.

10. The five-constant air-conditioning system of an aircraft cabin according to claim 9, wherein the cold and hot medium pipeline assembly is S-shaped and mounted on the inner wall of the cabin.
